(19) United States
(12) Patent Application Publication
(10) Pub. No.: US 2018/0060724 A1
(43) Pub. Date: Mar. 1, 2018

(54) Network Morphism

(71) Applicant: Microsoft Technology Licensing, LLC, Redmond, WA (US)

(72) Inventors: Changhu Wang, Beijing (CN); Yong Rui, Sammamish, WA (US); Tao Wei, Yishui (CN)

(21) Appl. No.: 15/247,673

(22) Filed: Aug. 25, 2016

(51) Int. Cl. G06N 3/08; G06N 5/02

(52) U.S. Cl. CPC G06N 3/08; G06N 5/02

(57) ABSTRACT

This disclosure describes techniques and architectures to morph well-trained networks to other related applications or modified networks with relatively little retraining. For example, a well-trained neural network (e.g., parent network) may be morphed to a new neural network (e.g., child network) so that the new neural network function may be preserved. After morphing a parent network, the child network may inherit the knowledge from its parent network and also may have a potential to continue growing into a more powerful network. Such morphing and growing may occur with a relatively short training time.

### BACKGROUND

Many different types of computer-implemented recognition systems exist, wherein such recognition systems are configured to perform some form of classification with respect to input data. For example, computer-implemented speech recognition systems are configured to receive spoken utterances of a user and recognize words in the spoken utterances. In another example, handwriting recognition systems have been developed to receive a handwriting sample and identify, for instance, an author of the handwriting sample, individual letters in the handwriting sample, words in the handwriting sample, etc. In still yet another example, computer-implemented recognition systems have been developed to perform facial recognition, fingerprint recognition, and the like.

Deep convolutional neural networks (DCNNs) have been successfully applied to such applications, among others. DCNNs are generally artificial neural networks with more than one hidden layer between input and output layers and may model complex non-linear relationships. The hidden layers in DCNNs provide additional levels of abstraction, thus increasing modeling capability. Though DCNNs have been so successful, training such networks is generally very time-consuming. For example, it may take weeks or months to train an effective deep network, let alone the exploration of diverse network settings.

### SUMMARY

This disclosure describes techniques and architectures to morph well-trained networks to other related applications or modified networks with relatively little retraining. For example, a well-trained neural network (e.g., parent network) may be morphed to a new neural network (e.g., child network) so that the neural network function of the parent network may be preserved in the child network. After morphing a parent network, the child network may inherit the knowledge from its parent network and also may have a potential to continue growing into a more powerful network. Such morphing and growing may occur with a much shortened training time, compared to the case where a redesigned child network is trained from scratch.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The term “techniques,” for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs)), quantum devices, such as quantum computers or quantum annealers, and/or other technique(s) as permitted by the context above and throughout the document.

### BRIEF DESCRIPTION OF THE DRAWINGS

The detailed description is set forth with reference to the accompanying figures. In the figures, the left-most digit of a reference number identifies the figure in which the reference number first appears. The use of the same reference numbers in different figures indicates similar or identical items or features.

FIG. 1 is a block diagram depicting an environment for processes performing network morphism, according to various examples.

FIG. 2 is a block diagram depicting a device for processes performing network morphism, according to various examples.

FIG. 3 is a schematic diagram of an example parent network.

FIG. 4 is a schematic diagram of an example child network.

FIG. 5 is a schematic diagram of an example parent network illustrating a convolution filter, according to some examples.

FIG. 6 is a schematic diagram of an example child network illustrating convolution filters used in linear morphism.

FIG. 7 is a listing of an algorithm for network morphism, according to some examples.

FIG. 8 is a listing of an algorithm for network morphism, according to other examples.

FIG. 9 is a schematic diagram of non-zero elements for various example network morphisms.

FIG. 10 is a schematic diagram of an example network illustrating a convolution filter and activation functions, according to some examples.

FIG. 11 is a schematic diagram of an example network illustrating convolution filters and activation functions used in nonlinear morphism.

FIG. 12 is a schematic diagram of an example network resulting from stand-alone width morphing, according to various examples.

FIG. 13 is a schematic diagram illustrating kernel size for an example parent network, according to some examples.

FIG. 14 is a schematic diagram illustrating kernel size for an example child network.

FIG. 15 is a schematic diagram of an example child network resulting from sequential subnet morphing, according to various examples.

FIGS. 16 and 17 are flow diagrams illustrating processes for stacked sequential subnet morphing, according to some examples.

FIG. 18 is a flow diagram illustrating a process of network morphism, according to some examples.

### DETAILED DESCRIPTION

Techniques and architectures described herein may be used to adapt well-trained networks to other related applications or modified networks with relatively little retraining. For example, a well-trained neural network (e.g., parent network) may be morphed to a new neural network (e.g., child network) so that the parent neural network function may be preserved. Such a morphing process is called network morphism. After morphing a parent network, the child network may inherit the knowledge from its parent network and also may have a potential to continue growing into a more powerful network. Such morphing and growing may occur with a much shortened training time, compared to the case where the process described herein is not used. For example, without the benefit of inheriting knowledge from a parent, the child may have to be subjected to a relatively long process of training, which may be longer than the training of the parent, in order to achieve the same knowledge as that of the parent. In other words, the child would have to be re-trained. Network morphism has an ability to handle diverse morphing types of networks, including changes of depth, width, kernel size, and subnet. In some examples, for a sequential neural network, the depth can be measured by the number of convolutional layers, and width can be measured by the number of channels. Kernel size may represent the receptive field size of the convolutional filter. A network is able to be divided into multiple parts, and each part is a subnet. To have such an ability, network morphism involves performing network morphism equations and morphing algorithms for all such types of morphing (e.g., changes of depth, width, kernel size, and subnet) for both classic and convolutional neural networks. Network morphism may also have an ability to deal with nonlinearity in a network. A family of parametric-activation functions may facilitate morphing of continuous nonlinear activation neurons, for example.

Mathematically, a morphism is a structure-preserving map from one mathematical structure to another. In the context of neural networks, network morphism refers to a parameter-transferring mapping from a parent network to a child network that preserves the parent network function and outputs.

In various examples, morphing types may include depth morphing, width morphing, kernel size morphing, and subnet morphing. In some implementations, network morphism output may be unchanged, and a complex morphing may be decomposed into basic morphing steps, which may allow the morphism to be solved relatively easily.

In some examples, network morphism may be applied to nonlinearity in a neural network. A parametric-activation function family may be used to deal with such nonlinearity. The parametric-activation function family may be defined as an adjoint function family for arbitrary nonlinear activation function and it may reduce a nonlinear operation to a linear one with a parameter that can be learned. Therefore, the network morphism of any continuous nonlinear activation neurons can be solved.

In various examples, network morphism is able to internally regularize a network, which may lead to an improved performance.

In some examples, a student network may mimic a teacher network, which usually involves learning from scratch. For example, a lighter network may be trained by mimicking an ensemble network. In another example, a shallower but wider network may mimic a deep and wide network. In still another example, a deeper but narrower network may be used to mimic a deep and wide network. In contrast, examples of network morphism described herein are different from such examples of mimicking. Instead of mimicking, a goal of network morphism may generally be to have the child network directly inherit the intact knowledge (network function) from the parent network. (This is why the networks are called “parent” and “child”, instead of “teacher” and “student,” for example). Another major difference is that the child network is not learned from scratch.

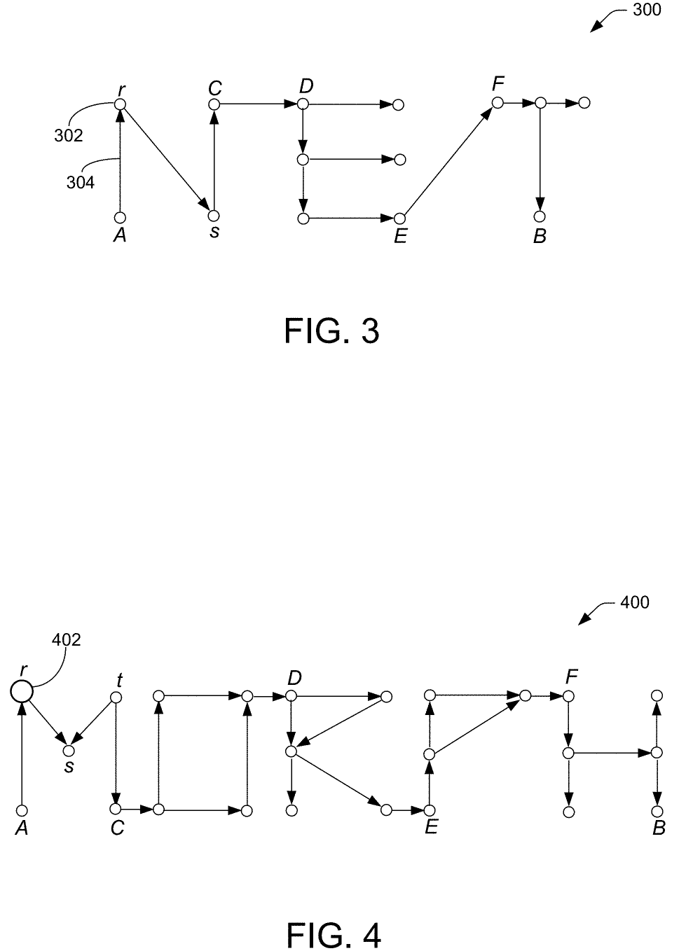

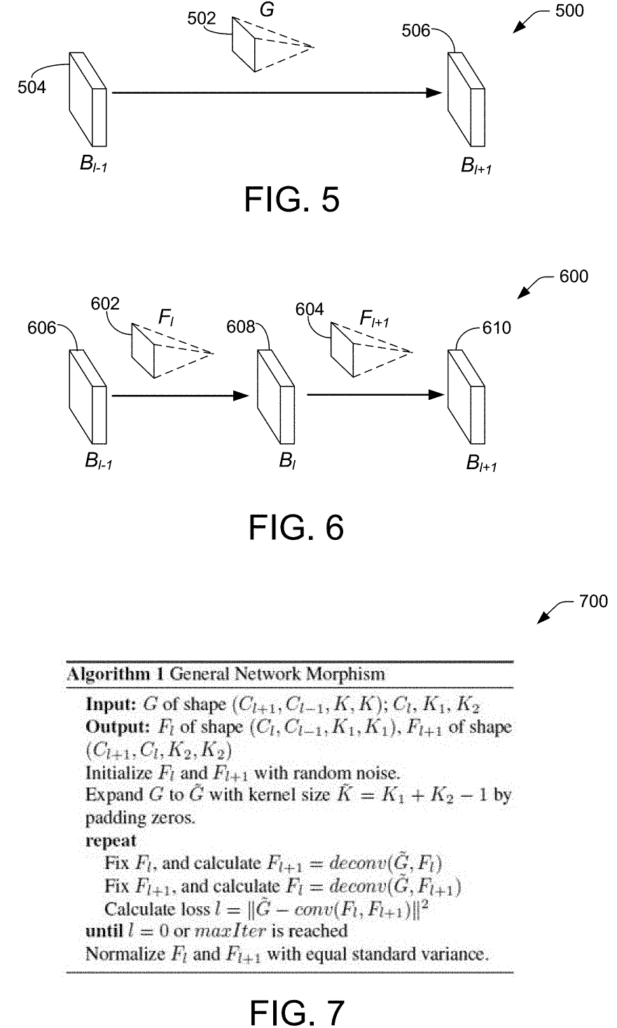

In some examples, pre-training is a strategy to facilitate the convergence of very deep neural networks. Transfer learning may be used to overcome an overfitting problem when training large neural networks on relatively small datasets. In some examples, overfitting is the behavior of a model that fits well for the training data, but has poor predictive performance. Pre-training and transfer learning both re-initialize the last few layers of a parent network while other layers remain unchanged (or are refined in a lighter way). In some examples, blobs are data blocks, and they are typically represented as a multi-dimensional array/tensor. A layer connects some input blobs and some output blobs, and may be also associated with some parameters. For a particular example, a convolutional layer connects one input blob and one output blob, and may be associated with a convolutional filter. (In a graph representation, such as in FIGS. 3 and 4, blobs are nodes, and layers are edges. In FIGS. 5, 6, 10, 11, 12, 15, blobs are illustrated as cuboids and layers are illustrated as wedges.) In contrast, examples of network morphism described herein are different from pre-training and transfer learning: pre-training continues to train the child network on the same dataset, while transfer learning continues on a new dataset. However, these two strategies alter the parameters in the last few layers, as well as the network function.

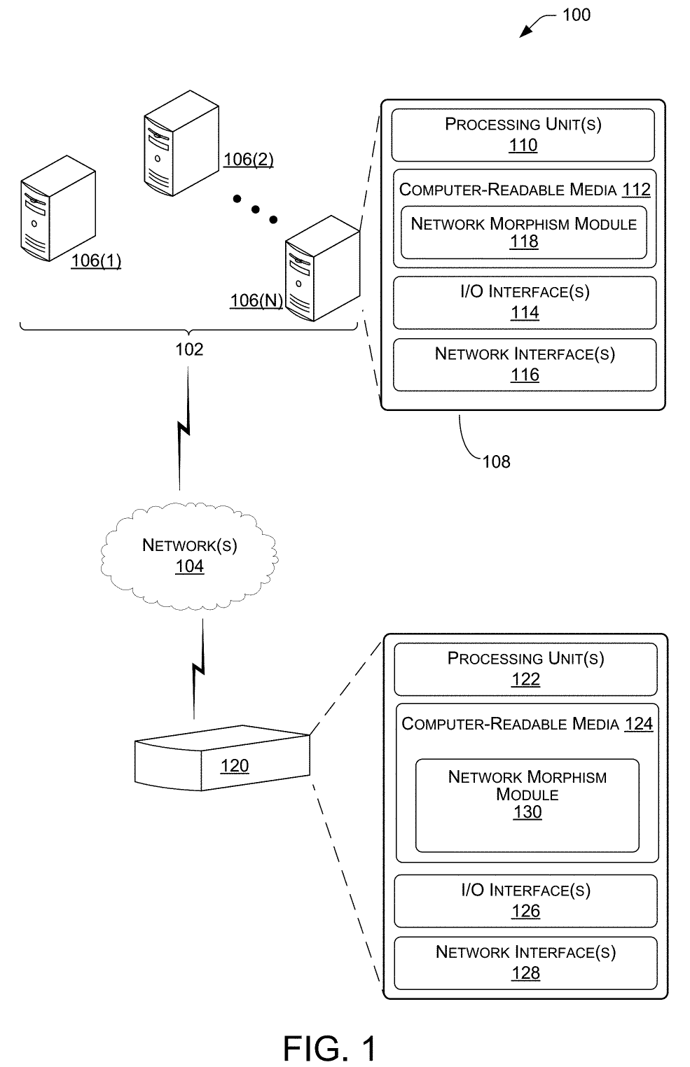

Various examples are described further with reference to FIGS. 1-18.

FIG. 1 is a block diagram depicting an environment 100 for processes performing network morphism, according to various examples. In some examples, the various devices and/or components of environment 100 include distributed computing resources 102 that may communicate with one another and with external devices via one or more networks 104.

For example, network(s) 104 may include public networks such as the Internet, private networks such as an institutional and/or personal intranet, or some combination of private and public networks. Network(s) 104 may also include any type of wired and/or wireless network, including but not limited to local area networks (LANs), wide area networks (WANs), satellite networks, cable networks, Wi-Fi networks, WiMax networks, mobile communications networks (e.g., 3G, 4G, 5G, and so forth) or any combination thereof. Network(s) 104 may utilize communications protocols, including packet-based and/or datagram-based protocols such as internet protocol (IP), transmission control protocol (TCP), user datagram protocol (UDP), or other types of protocols. Moreover, network(s) 104 may also include a number of devices that facilitate network communications and/or form a hardware basis for the networks, such as switches, routers, gateways, access points, firewalls, base stations, repeaters, backbone devices, and the like.

In some examples, network(s) 104 may further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 1302.11 standards (e.g., 1302.11g, 1302.11n, and so forth) and other standards. Network(s) 104 may also include network memory, which may be located in a cloud, for example. Such a cloud may be configured to perform actions based on executable code, such as in cloud computing, for example.

In various examples, distributed computing resource(s) 102 includes computing devices such as devices 106(1)-106(N). Examples support scenarios where device(s) 106 may include one or more computing devices that operate in a cluster or other grouped configuration to share resources, balance load, increase performance, provide fail-over support or redundancy, or for other purposes. Although illustrated as desktop computers, device(s) 106 may include a diverse variety of device types and are not limited to any particular type of device. Device(s) 106 may include specialized computing device(s) 108.

For example, device(s) 106 may include any type of computing device, including a device that performs cloud data storage and/or cloud computing, having one or more processing unit(s) 110 operably connected to computer-readable media 112, I/O interfaces(s) 114, and network interface(s) 116. Computer-readable media 112 may have a network morphism module 118 stored thereon. For example, network morphism module 118 may comprise computer-readable code that, when executed by processing unit(s) 110, perform processes for network morphism. In some cases, however, a network morphism module need not be present in specialized computing device(s) 108.

A computing device(s) 120, which may communicate with device(s) 106 (including network storage, such as a cloud memory/computing) via networks(s) 104, may include any type of computing device having one or more processing unit(s) 122 operably connected to computer-readable media 124, I/O interface(s) 126, and network interface(s) 128. Computer-readable media 124 may have a computing device-side network morphism module 130 stored thereon. For example, similar to or the same as network morphism module 118, network morphism module 130 may comprise computer-readable code that, when executed by processing unit(s) 122, causes the computing device(s) 120 to perform a process for network morphism. In some cases, however, a network morphism module need not be present in computing device(s) 120. For example, such a network morphism module may be located in network(s) 104.

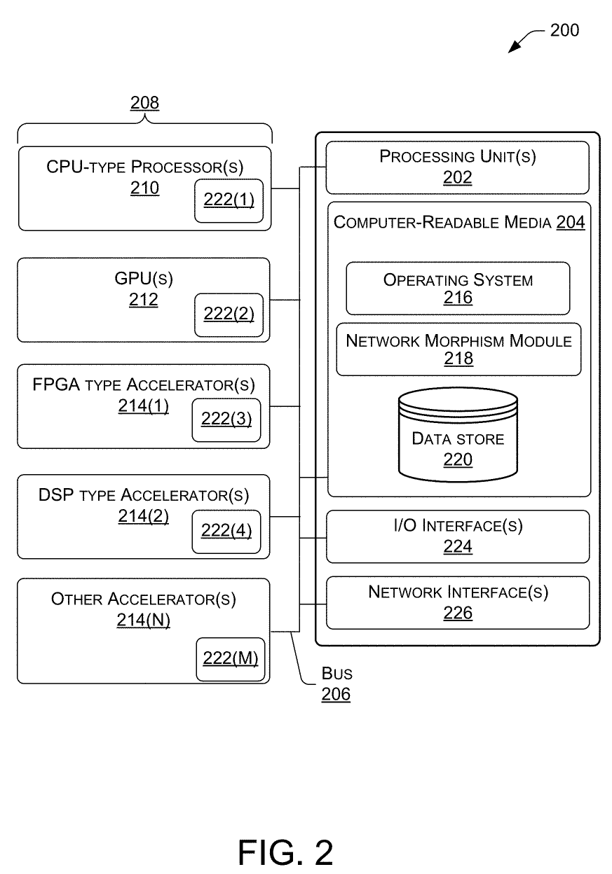

FIG. 2 depicts an illustrative device 200, which may represent device(s) 106 or 108, for example. Illustrative device 200 may include any type of computing device having one or more processing unit(s) 202, such as processing unit(s) 110 or 122, operably connected to computer-readable media 204, such as computer-readable media 112 or 124. The connection may be via a bus 206, which in some instances may include one or more of a system bus, a data bus, an address bus, a PCI bus, a Mini-PCI bus, and any variety of local, peripheral, and/or independent buses, or via another operable connection. In some implementations the bus 206 may be absent, and the various components may use a different architecture to interconnect. Processing unit(s) 202 may represent, for example, a CPU incorporated in device 200. The processing unit(s) 202 may similarly be operably connected to computer-readable media 204.

The computer-readable media 204 may include, at least, two types of computer-readable media, namely computer storage media and communication media. Computer storage media may include volatile and non-volatile machine-readable, removable, and non-removable media implemented in any method or technology for storage of information (in compressed or uncompressed form), such as computer (or other electronic device) readable instructions, data structures, program modules, or other data to perform processes or methods described herein. The computer-readable media 112 and the computer-readable media 124 are examples of computer storage media. Computer storage media include, but are not limited to hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions.

In contrast, communication media may embody computer-readable instructions, data structures, program modules, or other data in a modulated data signal, such as a carrier wave, or other transmission mechanism. As defined herein, computer storage media does not include communication media.

Device 200 may include, but is not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device such as one or more separate processor device(s) 208, such as CPU-based processors (e.g., micro-processors) 210, GPUs 212, or accelerator device(s) 214.

In some examples, as shown regarding device 200, computer-readable media 204 may store instructions executable by the processing unit(s) 202, which may represent a CPU incorporated in device 200. Computer-readable media 204 may also store instructions executable by an external CPU-based processor 210, executable by a GPU 212, and/or executable by an accelerator 214, such as an FPGA-based accelerator 214(1), a DSP-based accelerator 214(2), or any internal or external accelerator 214(N).

Executable instructions stored on computer-readable media 204 may include, for example, an operating system 216, a network morphism module 218, and other modules, programs, or applications that may be loadable and executable by processing units(s) 202, and/or 210. For example, network morphism module 218 may comprise computer-readable code that, when executed by processing unit(s) 202, perform processes for network morphism. In some cases, however, a network morphism module need not be present in device 200.

Alternatively, or in addition, the functionally described herein may be performed by one or more hardware logic components such as accelerators 214. For example, and without limitation, illustrative types of hardware logic components that may be used include Field-programmable Gate Arrays (FPGAs), Application-specific Integrated Circuits (ASICs), Application-specific Standard Products (ASSPs), quantum devices, such as quantum computers or quantum annealers, System-on-a-chip systems (SOCs), Complex Programmable Logic Devices (CPLDs), etc. For example, accelerator 214(N) may represent a hybrid device, such as one that includes a CPU core embedded in an FPGA fabric.

In the illustrated example, computer-readable media 204 also includes a data store 220. In some examples, data store 220 includes data storage such as a database, data warehouse, or other type of structured or unstructured data storage. In some examples, data store 220 includes a relational database with one or more tables, indices, stored procedures, and so forth to enable data access. Data store 220 may store data for the operations of processes, applications, components, and/or modules stored in computer-readable media 204 and/or executed by processor(s) 202 and/or 210, and/or accelerator(s) 214. For example, data store 220 may store version data, iteration data, clock data, and various state data stored and accessible by network morphism module 218. Alternately, some or all of the above-referenced data may be stored on separate memories 222 such as a memory 222(1) on board CPU type processor 210 (e.g., microprocessor(s)), memory 222(2) on board GPU 212, memory 222(3) on board FPGA type accelerator 214(1), memory 222(4) on board DSP type accelerator 214(2), and/or memory 222(M) on board another accelerator 214(N).

Device 200 may further include one or more input/output (I/O) interface(s) 224, such as I/O interface(s) 114 or 126, to allow device 200 to communicate with input/output devices such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). Device 200 may also include one or more network interface(s) 226, such as network interface(s) 116 or 128, to enable communications between computing device 200 and other networked devices such as other device 120 over network(s) 104 and network storage, such as a cloud network. Such network interface(s) 226 may include one or more network interface controllers (NICs) or other types of transceiver devices to send and receive communications over a network.

FIG. 3 is a schematic diagram of an example parent network 300. The network is represented by an arrangement of nodes (302 is one example of a node) connected by edges (304 is one example of an edge). Some of the nodes are labelled by letters A, r, s, C, D, E, F, and B.

As explained above, mathematically a morphism is a structure-preserving map from one mathematical structure to another. In the context of neural networks, network morphism refers to a parameter-transferring map from a parent network to a child network that preserves its function and outputs.

FIG. 4 is a schematic diagram of a child network 400 resulting from network morphism, according to some examples. Comparing child network 400 with parent network 300, a variety of morphing types are demonstrated, such as depth morphing, width morphing, kernel size morphing, and subnet morphing. Child network 400 may inherit the entire knowledge from parent network 300 with the network function preserved.

In child network 400, node 302 (node r) expands to an inflated node 402. The inflated node r involves width and kernel size morphing, for example. In child network 400, the change from the parent network of segment AC represents depth morphing s→s+t. In child network 400, the change from the parent network of segment CD, which is subnet morphing, is the inclusion of a subnet so that the subnet is embedded in segment CD. Complex network morphism can also be achieved with a combination of these basic morphing operations, for example.

FIG. 5 is a schematic diagram of an example parent network 500. The diagram also illustrates a convolution filter 502 and blobs 504 and 506, according to some examples. FIG. 6 is a schematic diagram of an example child network 600. The diagram also illustrates convolution filters 602, 604 and blobs 606, 608, and 610, according to some examples. Convolution filters such as 502, 602, and 604 may be used in linear network morphism. Herein, wedge shapes such as that of 502 are used to generally represent functions, as described for the respective figures below.

In some examples, at first all nonlinear activation functions may be dropped and a neural network may be considered only connected with fully connected layers.

As shown in FIG. 5, in parent network 500, two hidden layers Bₗ₋₁ and Bₗ₊₁ (504 and 506) are connected via convolution filter 502, which is a weight matrix G:

Bₗ₊₁=G·Bₗ₋₁, Eqn. (1)

where Bₗ₋₁ ∈ R^{C}^{_{l−1}}, Bₗ₊₁ ∈ R^{C}^{ₗ₊₁}, and G ∈ R^{C}^{ₗ₊₁}^{×C}^{_{l−1}}, where the symbol “∈” stands for “element of”. Cₗ₋₁ and Cₗ₊₁ are feature dimensions of Bₗ₋₁ and Bₗ₊₁. For network morphism, a new hidden layer Bₗ (layer 608) may be inserted so that the child network satisfies:

Bₗ₊₁=Fₗ₊₁·Bₗ=Fₗ₊₁·(Fₗ·bₗ₋₁)=G·Bₗ₋₁, Eqn. (2)

where Bₗ ∈ R^{C}^{ₗ}, Fₗ ∈ R^{C}^{ₗ}^{×C}^{_{l−1}}, and Fₗ₊₁ ∈ R^{C}^{ₗ₊₁}^{×C}^{ₗ}. Network morphism for classic neural networks may be equivalent to a matrix decomposition problem:

G=Fₗ₊₁·Fₗ Eqn. (3)

The case of a deep convolutional neural network (DCNN) may be considered. For example, for a DCNN, the build-up blocks may be convolutional layers rather than fully connected layers. Thus, the hidden units are called blobs, and weight matrices are filters. For a 2-dimensional (2D) DCNN, the blob B* is a 3-dimensional (3D) tensor of shape (C*, H*, W*), where C*, H*, and W* represent the number of channels, height, and width of B*, respectively. The filters G, Fₗ, and Fₗ₊₁ are 4-dimensional (4D) tensors of shapes (Cₗ₊₁, Cₗ₋₁, K, K), (C₁, Cₗ₋₁, K₁, Kₗ), and (Cₗ₊₁, Cₗ, K₂, K₂), where K, K₁, K₂ are convolutional kernel sizes. The convolutional operation in a DCNN can be defined in a multi-channel way:

Bₗ(cₗ)=ΣBₗ₋₁(cₗ₋₁)*Fₗ(cₗ, cₗ₋₁), Eqn. (4)

where the summation is taken over cₗ₋₁ and * is the convolution operation (e.g., defined in a traditional way). The filters Fₗ, Fₗ₊₁, and G satisfy the following equation:

Ĝ(cₗ₊₁, cₗ₋₁)=ΣFₗ(cₗ, cₗ₋₁)*Fₗ₊₁(cₗ₊₁, cₗ) Eqn. (5)

where the summation is taken over cₗ and Ĝ is a zero-padded version of G whose effective kernel size (receptive field) is \acute{K}=K₁+K₂−1≧K. If \acute{K}=K, then Ĝ=G. Mathematically, inner products are equivalent to multichannel convolutions with kernel sizes of 1×1. Thus, Equation (3) is equivalent to Equation (5) with K=K₁=K₂=1. Hence, these equations may be unified into one equation:

Ĝ=Fₗ₊₁ [symbol] Fₗ Eqn. (6)

where [symbol] is a non-communicative operator that can either be an inner product (e.g., for a classical neural network) or a multi-channel convolution (e.g., for a convolutional neural network). Equation (6) is called the network morphism equation (for depth in the linear case).

Although Equation (6) is primarily derived for depth morphing (G morphs into Fₗ and Fₗ₊₁), the equation also involves network width (the choice of Cₗ), and kernel sizes (the choice of K₁ and K₂). For example, regarding the input G, a choice of Cₗ determines width morphing and choices for K₁ and K₂ determine kernel size morphing. G morphs into Fₗ and Fₗ₊₁

The problem of network depth morphing is formally formulated as follows:
Input: G of shape (Cₗ₊₁, Cₗ₋₁, K, K); Cₗ, K₁, K₂.
Output: Fₗ of shape (Cₗ, Cₗ₋₁, K₁, K₁), Fₗ₊₁ of shape (Cₗ₊₁, Cₗ, K₂, K₂) that satisfies Equation (6).

FIG. 7 is a listing of algorithm 700 for network morphism, according to some examples. Algorithm 700 may be used to solve for the network morphism equation (6), for the linear case, for example.

As illustrated in FIG. 7, algorithm 700 initializes convolution kernels Fₗ and Fₗ₊₁ of the child network with random noise. Then the algorithm iteratively solves Fₗ₊₁ and Fₗ by fixing one or the other. For each iteration, Fₗ or Fₗ₊₁ may be solved by deconvolution. Deconvolution is the reverse operation of convolution, and it can be any algorithm that solves Fₗ (or Fₗ₊₁) when G and Fₗ₊₁ (or Fₗ) are given. Hence the overall loss is always decreasing and is expected to converge. However, it is not guaranteed that the loss in algorithm 700 will always converge to 0.

If the parameter number of either Fₗ or Fₗ₊₁ is no less than Ĝ, algorithm 700 shall converge to 0. If the following condition of equation (7) is satisfied, the loss in algorithm 700 shall converge to 0 (in one step):

max(CₗCₗ₋₁K₁², Cₗ₊₁CₗK₂²)≧Cₗ₊₁Cₗ₋₁(K₁+K₂−1)² Eqn. (7)

The three items in the condition of equation (7) are the parameter numbers of Fₗ, Fₗ₊₁, and Ĝ, respectively.

The correctness of the condition of equation (7) can be checked since a multi-channel convolution can be written as the multiplication of two matrices. The condition of equation (7) is satisfied if there are more unknowns than constraints, and hence it is an undetermined linear system. Since random matrices are rarely inconsistent (with probability near zero), the solutions of the undetermined linear system may always exist.

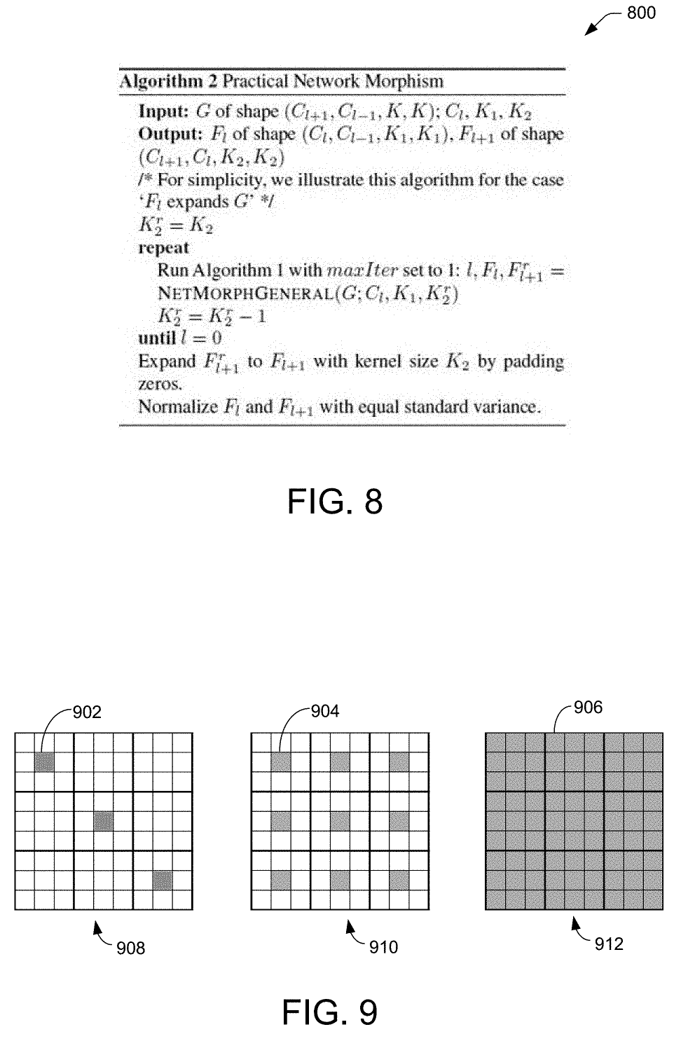

FIG. 8 is a listing of algorithm 800 for network morphism, according to some examples. While algorithm 700 fills in all the parameters with nonzero elements under certain conditions, algorithm 800 does not depend on such filling but can only asymptotically fill in all parameters with non-zero elements. Essentially, algorithm 800 is a variant of algorithm 700 that can solve Equation (6) with a sacrifice in the non-sparse practice. Algorithm 800 reduces the zero-converging condition so that the parameter number of either Fₗ or Fₗ₊₁ is no less than G, instead of Ĝ. Since network morphism is considered herein to be in an expanding mode, this condition may be assumed to be self-justified, namely, either Fₗ expands G, or Fₗ₊₁ expands G. Thus, this algorithm solves the network morphism equation (6). As described in algorithm 800, for the case that Fₗ expands G, starting from K₂^{r}=K₂, algorithm 700 may be iteratively called to shrink the size of K₂^{r} until the loss converges to 0. This iteration will terminate as a result of a guarantee that if K₂^{r}=1, the loss is 0. For the other case that Fₗ₊₁ expands G, the algorithm is applied in a similar fashion.

FIG. 9 is a schematic diagram of non-zero elements for various example network morphisms. Depth morphing is generally a relatively important morphing type, since neural networks continue to be going increasingly deeper. One heuristic approach is to embed an identity mapping layer into the parent network. This approach, which is referred to as IdMorph, is potentially problematic due to the sparsity of the identity layer, and might fail sometimes. To overcome the issues associated with IdMorph, several practices for the morphism operation are introduced and explained below. Such practices may be based at least in part on deconvolution-based process for network depth morphing. This process is able to asymptotically fill in all parameters with non-zero elements. In its worst case, the non-zero occupying rate of the proposed process is still higher than IdMorph by an order of magnitude.

In FIG. 9, illustrates non-zero element occupations for different processes. FIG. 9 compares the non-zero element occupations for IdMorph and another heuristic approach called NetMorph. Non-zero elements are indicated as gray (a few of which are labelled 902, 904, and 906). Case 908 corresponds to IdMorph in O(C), where O stands for “order of”. Case 910 corresponds to NetMorph worst case in O(C²). Case 912 corresponds to NetMorph best case in O(C²K²). C and K represent the channel size and kernel size, respectively. FIG. 9 illustrates a 4D convolutional filter of shape (3; 3; 3; 3) flattened in 2D. It can be seen that the filter in IdMorph is relatively sparse due to there only being three gray elements in case 908.

Thus, the sacrifice of the non-sparse practice in algorithm 800 may have a worst case, where it may not be able to fill in all parameters with non-zero elements, but may nevertheless fill asymptotically. It may be assumed that Cₗ₊₁=O(Cₗ), which is of the order of O(C). In the best case 912, NetMorph is able to occupy all the elements by non-zeros, with an order of O(C²K²). In the worst case 910, it has an order of O(C²) non-zero elements. Generally, NetMorph lies in between the best case and worst case. IdMorph, case 908, only has an order of O(C) non-zeros elements. Thus the nonzero occupying rate of NetMorph is higher than IdMorph by at least one order of magnitude.

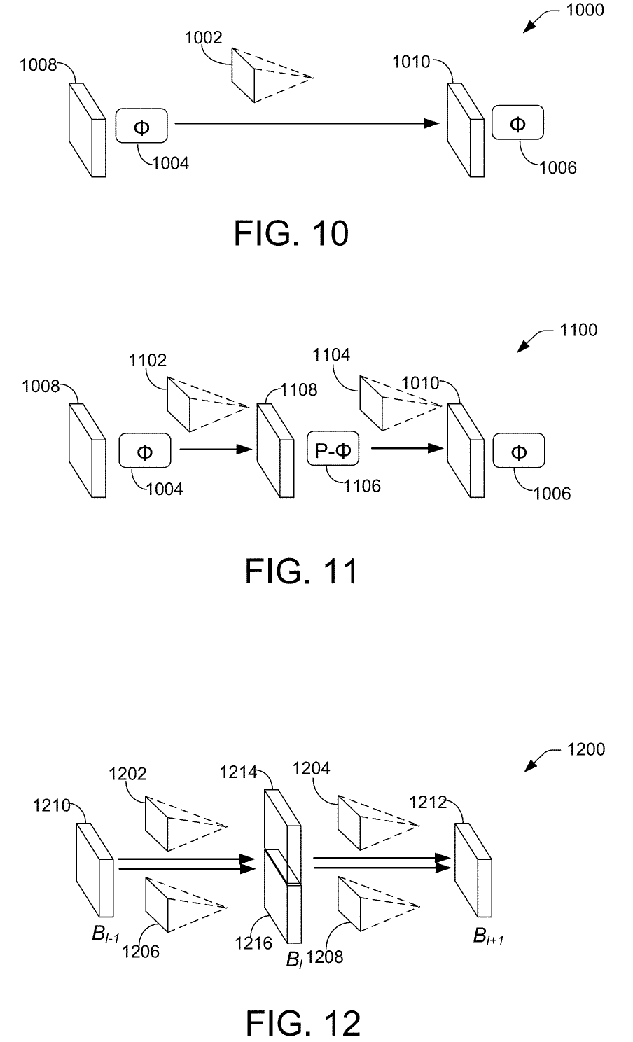

FIG. 10 is a schematic diagram of a parent network 1000 illustrating a convolution filter 1002 and activation functions 1004 and 1006, according to some examples. Blobs 1008 and 1010 may be similar to or the same as blobs 504 and 506, respectively, for example. FIG. 11 is a schematic diagram of an example child network 1100 illustrating morphed convolution filters 1102, 1104, new activation function 1106, and new blob 1108 resulting from nonlinear morphism.

Extending some ideas from the linear case, in general, it may not be trivial to replace the layer Bₗ₊₁=σ(G [symbol] Bₗ₋₁) with two layers Bₗ₊₁=Σ(Fₗ₊₁ [symbol] φ(Fₗ [symbol] Bₗ₋₁)), where φ represents the nonlinear activation function.

For an idempotent activation function satisfying φ [symbol] φ=φ, the IdMorph scheme in Net2Net is to set Fₗ₊₁=I, and Fₗ=G, where I represents the identity mapping. This results in

φ(I [symbol] φ(G [symbol] Bₗ₋₁))=φ [symbol] φ(G [symbol] Bₗ₊₁)=φ(G [symbol] Bₗ₊₁) Eqn. (8)

However, although IdMorph works for the rectified linear unit (ReLU) of this activation function, it may not be applied to other commonly used activation functions, such as Sigmoid and TanH, for example, since the idempotent condition is not satisfied.

To handle arbitrary continuous nonlinear activation functions, a P-activation function family may be used (e.g., P conceptually stands for parametric). A family of P-activation functions for an activation function φ can be defined to be any continuous function family that maps φ to the linear identity transform φ_{id}:x→x. The P-activation function family for φ may not be uniquely defined. The canonical form for P-activation function family is:

P_{-φ}≡{φ^{a}}|ₐ_{_{∈}}_{[0,1]}={(1−a)·φ+a·φ_{id}}|ₐ_{_{∈}}_{[0,1]}, Eqn. (9)

where a is the parameter to control the shape morphing of the activation function. Also, φ₀=φ, and φ₁=φ_{id}. The concept of the P-activation function family extends the parametric ReLU (PReLU) and the definition of PReLU coincides with the canonical form of the P-activation function family for the ReLU nonlinear activation unit.

The idea of leveraging the P-activation function family for network morphism is illustrated in FIG. 11, as compared to the parent network of FIG. 10. For example, the nonlinear activation functions 1004 and 1006 may be added, while activation function 1106 may be equivalent to a linear activation initially. This linear activation may grow into a nonlinear one subsequent to the value of a has been learned. Formally, the layer Bₗ₊₁=φ(G [symbol] Bₗ₊₁) may be replaced with two layers Bₗ₊₁=φ(Fₗ₊₁ [symbol] φ(Fₗ [symbol] Bₗ₋₁)). If a is set to be equal to 1, the morphing may be successful as long as the network morphing equation (6) is satisfied:

φ(Fₗ₊₁ [symbol] φ^{a}(Fₗ [symbol] Bₗ₋₁))=φ(Fₗ₊₁ [symbol] Fₗ [symbol] Bₗ₋₁)=φ(G [symbol] Bₗ₋₁) Eqn. (10)

The value of a may be learned as the model is continued to be trained.

FIG. 12 is a schematic diagram of an example network 1200 resulting from stand-alone width morphing, according to various examples. In the network 1200, a parent network includes convolutional filters 1202, 1204 and blobs 1210, 1212, 1214. A child network includes convolutional filters 1202-1208 and blobs 1210-1216. Convolutional filter 1202 is widened to 1202 and 1206, and convolutional filter 1204 is widened to 1204 and 1208.

For width morphing, Bₗ₋₁, Bₗ, Bₗ₊₁ may be assumed to all be parent network layers, and a goal is to expand the width (e.g., channel size) of Bₗ from Cₗ to Ĉ, where Ĉₗ≧Cₗ. For the parent network:

Bₗ(cₗ)=ΣBᵢ₋₁(cₗ₋₁)*Fₗ(cₗ, cₗ₋₁), Eqn. (12)

where the summation is taken over cₗ₋₁. Also,

Bₗ₊₁(c_{l 1})=ΣBₗ(cₗ)*Fₗ₊₁(cₗ₊₁, cₗ), Eqn. (13)

where the summation is taken over cₗ. For the child network, Bₗ₊₁ should be kept unchanged:

Bₗ₊₁(cₗ₋₁)=ΣBₗ(ĉₗ)*\dot{F}ₗ₊₁(cₗ₊₁, ĉ₁), Eqn. (14)

which is equal to

ΣBₗ(cₗ)*Fₗ₊₁(cₗ₊₁, cₗ)+ΣBₗ(cₗ′)*\dot{F}ₗ₊₁(cₗ₊₁, cₗ′), Eqn. (15)

where the summation in equation (14) is taken over ĉₗ, the first summation in equation (15) is taken over cₗ, and the second summation in equation (15) is taken over cₗ′. Also, ĉₗ and cₗ are the indices of the channels of the child network blob \dot{B}ₗ and parent network blob Bₗ. cₗ′ is the index of the complement ĉₗ\cₗ. Thus,

0=ΣBₗ(cₗ′)*\dot{F}ₗ₊₁(cₗ₊₁, cₗ′), Eqn. (16)

which is equal to

=ΣBₗ₋₁(cₗ₋₁)*\dot{F}ₗ(cₗ′, cₗ₋₁)*\dot{F}ₗ₋₁(cₗ₊₁, cₗ′), Eqn. (17)

or

\dot{F}ₗ(cₗ′, cₗ₋₁)*\dot{F}ₗ₊₁(cₗ₊₁, cₗ′)=0 Eqn. (18)

Either the first term or the second term in equation (18) may be set to 0, and the other (that is not set to zero) may be set arbitrarily. Following the non-sparse practice, the term having less parameters may be set to 0, and the other one to random noises, for example. The zeros and random noises in \dot{F}ₗ and \dot{F}ₗ₊₁ may be clustered together. To break this unwanted behavior, a random permutation may be performed on ĉₗ, which will not change Bₗ₊₁.

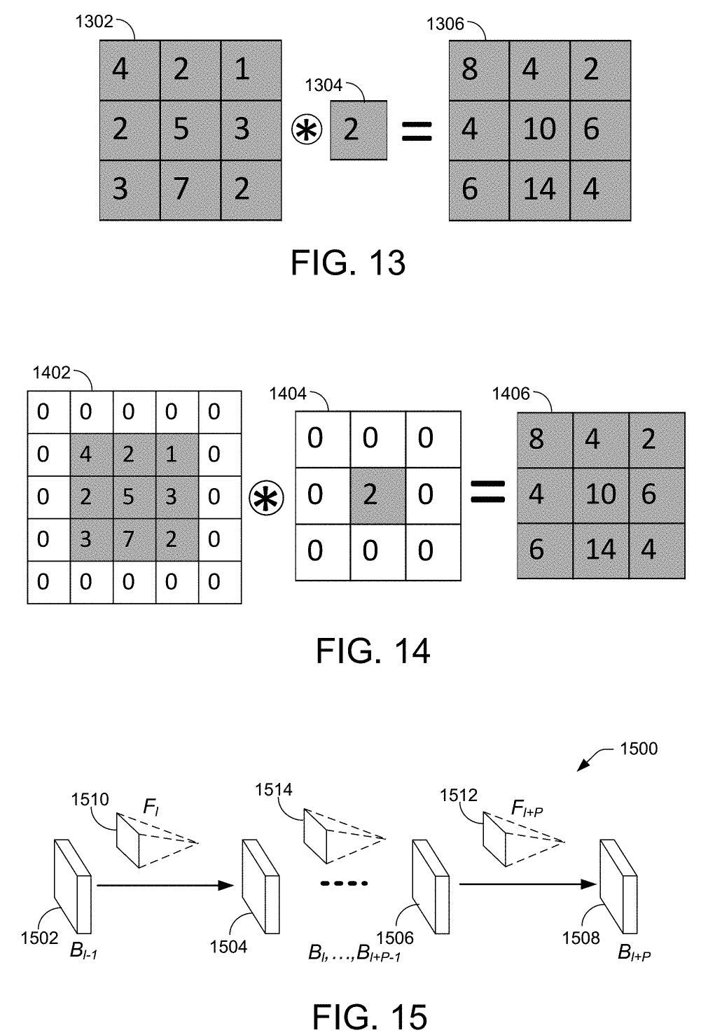

FIG. 13 is a schematic diagram illustrating kernel size for an example parent network, according to some examples. FIG. 14 is a schematic diagram illustrating kernel size for an example child network resulting from network morphism in kernel size.

For kernel size morphing, a heuristic approach may be taken. For a particular example, a convolutional layer l has kernel size of Kₗ(1304) and is to be expanded to \acute{K}ₗ (1404). If the filters of layer l are padded with (\acute{K}ₗ−Kₗ)/2 zeros on each side, the same operation may also apply for the blobs 1302 and 1402. The resulting blobs 1306 and 1406 are of the same shape and also with the same values.

FIG. 15 is a schematic diagram of a child network 1500 resulting from sequential subnet morphing of the parent network 500 (FIG. 5), according to various examples. Subnet morphing may be a type of network morphism starting from a relatively small number (e.g., 1) of layers in the parent network to a subnet in the child network. Sequential subnet morphing is to morph from a single layer (e.g., 504 and 506 of FIG. 5) to multiple sequential layers (e.g., 1502, 1504, 1506, and 1508). Similar to Equation (6), one can derive the network morphism equation for sequential subnets from a single layer to P+1 layers:

Ĝ(c_{l+P}, cₗ₋₁)=ΣFₗ(cₗ, cₗ₋₁)* . . . *F_{l+P}(c_{l+P}, c_{l+P-1}) Eqn. (19)

where the summation is taken from cₗ to c_{l+P-1}, Ĝ is a zero-padded version of G, and convolution filters 1510 and 1512 are Fₗ and F_{l+P}, respectively. 1514 represents multiple convolutional filters, wherein the dashed line in FIG. 15 represents blobs Bₗ, . . . , B_{l+P-1}, for every two blobs, and in between there is a convolutional filter. Its effective kernel size is \acute{K}=ΣKₗ₊ₚ−P, and Kₗ is the kernel size of layer l.

Similar to process 1 (FIG. 7), subnet morphing equation (19) can be solved by iteratively optimizing the parameters for one layer with the parameters for the other layers fixed. A practical version of such a process may be developed that can solve for Equation (19), which is similar to process 2 (FIG. 8).

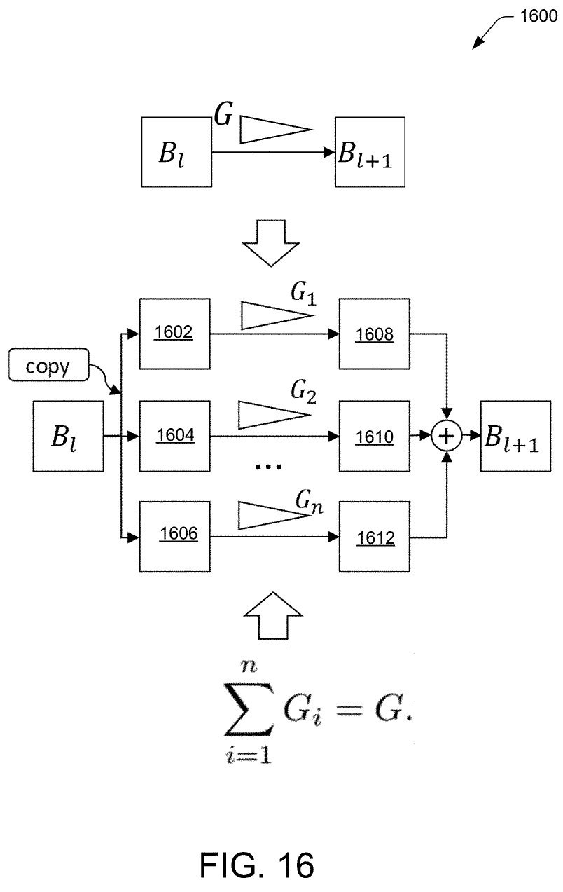

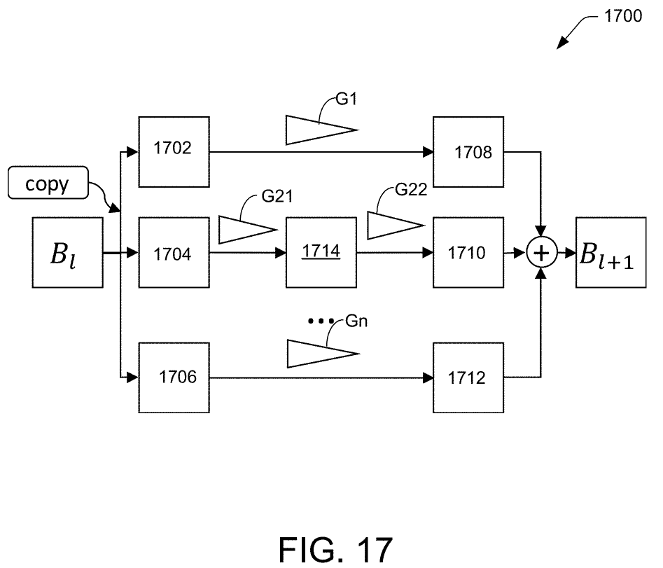

FIGS. 16 and 17 are flow diagrams illustrating processes 1600, 1700 for stacked sequential subnet morphing, according to some examples.

First, a single layer in the parent network (e.g., 500) may be split and copied into multiple paths. The split {Gᵢ} is set to satisfy

ΣGᵢ=G Eqn. (20)

where the summation is taken from i=1 to n, and the simplest case is Gᵢ=(1/n)G. Then, for each path, a sequential subnet morphing may be performed. For example, FIG. 16 illustrates an n-way stacked sequential subnet morphing, with the second path morphed into two layers. 1602-1606 are copies of Bₗ, 1608-1612 are G₁, G₂, G₃ convolved with 1602-1606, respectively. Bₗ₊₁ is the sum of 1608-1612. In FIG. 17, 1702-1706 are copies of 1708-1712 are G₁, G₂, G₃ convolved with 1702-1706, respectively. Bₗ₊₁ is the sum of 1708-1712, and G₂ is morphed into G₁₂ and G₂₂.

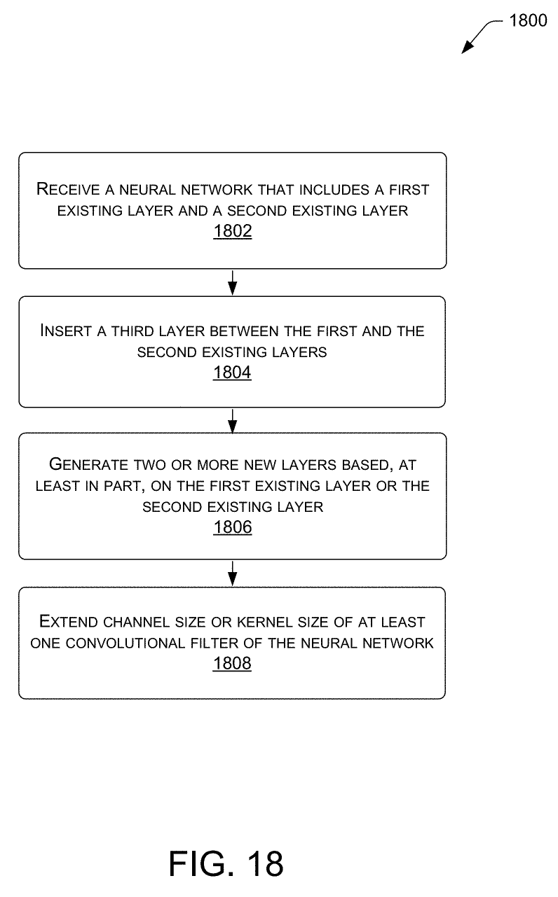

FIG. 18 is a flow diagram illustrating a process of network morphism, according to some examples. The flows of operations illustrated in FIG. 18 are illustrated as a collection of blocks representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor to perform the recited operations. In the context of hardware, the blocks may represent one or more circuits (e.g., FPGAs, application specific integrated circuits—ASICs, etc.) configured to execute the recited operations.

Any process descriptions, variables, or blocks in the flows of operations illustrated in FIG. 18 may represent modules (e.g., network morphism module 118, 130, or 218), segments, or portions of code that include one or more executable instructions for implementing specific logical functions or variables in the process.

Process 1800 may be performed by a processor such as processing unit(s) 110, 122, and 202, or network morphism module 118, 130, or 218, for example. At 1802, the processor may receive a neural network that includes a first existing layer and a second existing layer. For example, such existing layers may be represented by Bₗ₋₁ and Bₗ₊₁, as used in equation (1) (e.g., 504 and 506 in FIG. 5). In some situations, the first neural network may be a class neural network that may be modelled as multiple layer perceptrons (MLP). For example, MLP is a standard model in machine learning. MLP is a feedforward artificial neural network model that may map sets of input data onto outputs, with each layer fully connect to the next. At block 1804, the processor may insert a third layer between the first and the second existing layers. For example, a third layer may be represented by Bₗ, as illustrated in FIG. 6. At block 1806, the processor may generate two or more new layers based, at least in part, on the first existing layer or the second existing layer. At block 1808, the processor may extend channel size or kernel size of at least one convolutional filter of the neural network. For example, such convolution filters may be represented by Fₗ, Fₗ₊₁, and G, as used in equation (2).

In some examples, a non-communicative operator may either be an inner product (e.g., for a classical neural network, e.g., as in the case for equation (3)) or a multi-channel convolution (e.g., for a convolutional neural network), for example. A weight matrix may be represented by G, as used in equation (3). For example, as discussed above, for a DCNN, build-up blocks may be convolutional layers rather than fully connected layers. Thus, weight matrices may be filters.

In some examples, the processor may form a second neural network based, at least in part, on a weight matrix. The second neural network may inherit the knowledge from the first neural network (e.g., child network of the second neural network) and also may have a potential to continue growing into a more powerful network.

### EXAMPLE CLAUSES

The following clauses described multiple possible embodiments for implementing the features described in this disclosure. The various embodiments described herein are not limiting nor is every feature from any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.

A. A system comprising: one or more processors; and memory storing instructions that, when executed by the one or more processors, configure the system to perform operations comprising: receiving a first neural network having a first level of knowledge; and morphing the first neural network to form a second neural network so that the second neural network inherits the first level of knowledge from the first neural network.

B. The system as paragraph A recites, wherein the first neural network is a class neural network (multiple layer perceptrons).

C. The system as paragraph A recites, wherein the first neural network is a deep convolutional neural network (DCNN).

D. The system as paragraph A recites, wherein the operations further comprise training the second neural network to increase the first level of knowledge to a second level of knowledge.

E. A method for morphing a neural network, the method comprising: receiving the neural network that includes a first existing layer and a second existing layer; inserting a third layer between the first and the second existing layers; generating two or more new layers based, at least in part, on the first existing layer or the second existing layer; and extending channel size or kernel size of at least one convolutional filter of the neural network.

F. The method as paragraph E recites, further comprising: splitting the third layer of the neural network to two or more stacked layers.

G. The method as paragraph E recites, wherein at least one of the first existing layer or the second existing layer is a fully connected layer.

H. The method as paragraph E recites, wherein the third layer is a fully connected layer.

I. The method as paragraph E recites, wherein the layer is a convolutional layer.

J. The method as paragraph E recites, wherein at least one of the first existing layer or the second existing layer is a convolutional layer.

K. The method as paragraph E recites, further comprising padding the weight matrix or convolution filter with zeroes.

L. The method as paragraph E recites, wherein morphing the neural network includes width morphing.

M. The method as paragraph E recites, wherein morphing the neural network includes kernel size morphing.

N. The method as paragraph E recites, further comprising forming a second neural network by morphing the first neural network by subnet.

O. The method as paragraph N recites, wherein at least a portion of the neural network is nonlinear, and wherein forming the second neural network is based, at least in part, on a parametric-activation function.

P. The method as paragraph O recites, wherein the parametric-activation function includes one or more parameters, the method further comprising training the one or more parameters over a time span.

Q. A method comprising: receiving a parent neural network at least partially defined by a network function and outputs, wherein the parent neural network comprises a nonlinear portion of nodes and segments; morphing the depth of at least a portion of the nodes; after morphing the depth, morphing the width and kernel size of at least another portion of the nodes to generate a child neural network such that the child neural network preserves the network function and the outputs of the parent neural network.

R. The method as paragraph Q recites, further comprising: after morphing the width and the kernel size, morphing at least a portion of the segments to generate a subnet morphing of the parent neural network.

S. The method as paragraph Q recites, further comprising applying a parametric-activation function to the nonlinear portion of nodes and segments.

T. The method as paragraph S recites, wherein the parametric-activation function includes one or more parameters, the method further comprising training the one or more parameters over a time span.

Although the subject matter has been described in language specific to structural features and/or methodological acts, it is to be understood that the subject matter defined in the appended claims is not necessarily limited to the specific features or acts described. Rather, the specific features and steps are disclosed as example forms of implementing the claims.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “may” or “may,” unless specifically stated otherwise, are understood within the context to present that certain examples include, while other examples do not include, certain features, variables and/or steps. Thus, such conditional language is not generally intended to imply that certain features, variables and/or steps are in any way required for one or more examples or that one or more examples necessarily include logic for deciding, with or without user input or prompting, whether certain features, variables and/or steps are included or are to be performed in any particular example.

Conjunctive language such as the phrase “at least one of X, Y, or Z,” unless specifically stated otherwise, is to be understood to present that an item, term, etc. may be either X, Y, or Z, or a combination thereof

Any process descriptions, variables or blocks in the flow diagrams described herein and/or depicted in the attached figures should be understood as potentially representing modules, segments, or portions of code that include one or more executable instructions for implementing specific logical functions or variables in the routine. Alternate implementations are included within the scope of the examples described herein in which variables or functions may be deleted, or executed out of order from that shown or discussed, including substantially synchronously or in reverse order, depending on the functionality involved as would be understood by those skilled in the art.

It should be emphasized that many variations and modifications may be made to the above-described examples, the variables of which are to be understood as being among other acceptable examples. All such modifications and variations are intended to be included herein within the scope of this disclosure and protected by the following claims.

What is claimed is:

1. A system comprising:
one or more processors; and
memory storing instructions that, when executed by the one or more processors, configure the system to perform operations comprising:
receiving a first neural network having a first level of knowledge; and
morphing the first neural network to form a second neural network so that the second neural network inherits the first level of knowledge from the first neural network.

2. The system of claim 1, wherein the first neural network is a class neural network (multiple layer perceptrons).

3. The system of claim 1, wherein the first neural network is a deep convolutional neural network (DCNN).

4. The system of claim 1, wherein the operations further comprise training the second neural network to increase the first level of knowledge to a second level of knowledge.

5. A method for morphing a neural network, the method comprising:
receiving the neural network that includes a first existing layer and a second existing layer;
inserting a third layer between the first and the second existing layers;
generating two or more new layers based, at least in part, on the first existing layer or the second existing layer; and
extending channel size or kernel size of at least one convolutional filter of the neural network.

6. The method of claim 5, further comprising:
splitting the third layer of the neural network to two or more stacked layers.

7. The method of claim 5, wherein at least one of the first existing layer or the second existing layer is a fully connected layer.

8. The method of claim 5, wherein the third layer is a fully connected layer.

9. The method of claim 5, wherein the layer is a convolutional layer.

10. The method of claim 5, wherein at least one of the first existing layer or the second existing layer is a convolutional layer.

11. The method of claim 5, further comprising padding the weight matrix or convolution filter with zeroes.

12. The method of claim 5, wherein morphing the neural network includes width morphing.

13. The method of claim 5, wherein morphing the neural network includes kernel size morphing.

14. The method of claim 5, further comprising forming a second neural network by morphing the first neural network by subnet.

15. The method of claim 14, wherein at least a portion of the neural network is nonlinear, and wherein forming the second neural network is based, at least in part, on a parametric-activation function.

16. The method of claim 15, wherein the parametric-activation function includes one or more parameters, the method further comprising training the one or more parameters over a time span.

17. A method comprising:
receiving a parent neural network at least partially defined by a network function and outputs, wherein the parent neural network comprises a nonlinear portion of nodes and segments;
morphing the depth of at least a portion of the nodes;
after morphing the depth, morphing the width and kernel size of at least another portion of the nodes to generate a child neural network such that the child neural network preserves the network function and the outputs of the parent neural network.

18. The method of claim 17, further comprising:
after morphing the width and the kernel size, morphing at least a portion of the segments to generate a subnet morphing of the parent neural network.

19. The method of claim 17, further comprising applying a parametric-activation function to the nonlinear portion of nodes and segments.

20. The method of claim 19, wherein the parametric-activation function includes one or more parameters, the method further comprising training the one or more parameters over a time span.
